(19) United States
(12) Patent Application Publication
(10) Pub. No.: US 2007/0122546 A1
(43) Pub. Date: May 31, 2007

(54) Texturing pads and slurry for magnetic heads

(76) Inventor: Mort Cohen, Danville, CA (US)

Correspondence Address: ANDREW ALEXANDER & ASSOCIATES, 3124 KIPP AVENUE, P.O. BOX 2038, LOWER BURRELL, PA, 15068, US

(21) Appl. No.: 11/511,092

(22) Filed: Aug. 28, 2006

Related U.S. Application Data
(60) Provisional application No. 60/739,201, filed on Nov. 25, 2005.
(60) Provisional application No. 60/755,295, filed on Jan. 3, 2006.

(51) Int. Cl. B05D 5/12; B24D 3/02

(52) U.S. Cl. 427/127; 51/308

(57) ABSTRACT

A method of texturing a slider surface on a magnetic head for reading and writing information on a hard disk, the texturing applied to prevent stiction between the hard disk and the slider surface. The method comprises the steps of providing a sliding head having a surface having a smoothness of 6 Å or less to provide a polished surface. The polished surface is textured by contacting it with a texturing pad having a texturing surface comprised of a polyester material and a slurry comprised of colloidal silica. The polished surface is treated with the texturing pad and colloidal silica to provide a surface having a roughness greater than that of the polished surface. The polished surface avoids stiction between the slider surface and the hard disk.

### CROSS REFERENCE TO RELATED APPLICATION

This application claims the benefit of U.S. Provisional Application Nos. 60/739,201, filed Nov. 25, 2005 and 60/755,295, filed Jan. 3, 2006, incorporated herein by reference.

### BACKGROUND OF THE INVENTION

This invention relates to magnetic heads for reading and writing information on a hard disk, and more particularly, it relates to texturing pads and slurry for treating magnetic heads for better performance.

The hard disk is usually composed of a polished nickel plated aluminum substrate or glass substrate. The polish nickel substrate is textured using tape and subsequently sputtered with a chromium, cobalt and carbon thin film. Finally, the disk is given a thin lubrication film of fluorocarbon.

The head in a disk drive reads and records information on the hard disk. The head consists of a transducer and a slider. The slider comes very close to being in contact with the disk surface, which is rotating during operation at 7,000-9,000 rpm. The heads are referred to as GMR (giant magnetic resistive heads) or TMR (tunneling magneto resistive heads) heads.

The slider on the head is made from a sintered composite of aluminum oxide and titanium carbide and is sometimes referred to as “altic”. The altic is flattened or lapped using a lapping machine employing a rotating lapping table or lapping plate made out of a tin alloy. The lapping plate has circumferential grooves, somewhat like a phonograph record, that are charged with a mixture of fine (100 nm to 200 nm) polycrystalline diamonds mixed in an oil or synthetic oil. The slider is lapped or polished on the lapping plate and produces a surface which is extremely flat and smooth, e.g., RMS less than 5 Å. The resulting smooth head is required to fly very close to the hard disk to read or write bits of magnetic information. However, the extreme smoothness also can be a problem because stiction can occur. Stiction causes the head to stick to the disk, preventing lift and easy movement of the head.

Prior references disclose slider for heads, polishing techniques and the problems associated therewith. For example, U.S. Pat. No. 6,195,235 discloses a slider for supporting transducer elements in a data storage system including a granular particle composition including multiple layers of particles for providing a contact interface between the slider and disc surface. The multiple particle layers provide an uneven surface structure for stiction control. The multiple particle layers provide for wear while maintaining an uneven surface structure for stiction control.

U.S. Patent Publication 2004/0162010 discloses a polishing sheet produced by preparing a woven cloth sheet with single fibers, fiber bundles obtained by tying a plurality of fibers together, or bundle groups obtained by tying together these fiber bundles and impregnating such a woven cloth sheet with a resin solution such that the fibers and/or fiber bundles are fixed together. A backing sheet may be used to attach such a polishing sheet. Sateen woven cloths with sateen number 3-15 are preferred.

U.S. Pat. No. 5,733,178 discloses a method for texturing magnetic recording media substrates using a structured abrasive article including a flexible backing having a major surface and an abrasive coating, the abrasive coating attached to and at least substantially covering the entire total surface area of the major surface, where the abrasive coating includes a plurality of precisely-shaped three-dimensional abrasive composites, and the composites comprise a plurality of abrasive particles dispersed in a binder, which binder provides the means of attachment of the composites to the backing.

U.S. Pat. No. 5,899,794 discloses a method for polishing or texturing a magnetic disc, comprising bringing a tape traveled in a predetermined direction and made of fibers having a fineness of not more than 0.1 denier, and a slurry containing polishing grains dispersed therein, into contact with a substrate of the magnetic disc. Such method has an extremely low surface roughness (Ra) and an extremely low maximum projection height (Rp) with an excellent high accuracy, thereby efficiently producing a magnetic recording medium which is free from head crash and errors upon reading and writing of information.

U.S. Pat. No. 5,904,159 discloses a polishing slurry formed of a silica-dispersed solution obtained by dispersing, in an aqueous solvent, a fumed silica having an average primary particle size of from 5 to 30 nm, the silica-dispersed solution exhibiting a light scattering index (n) of from 3 to 6 at a silica concentration of 1.5% by weight, and the fumed silica dispersed therein having an average secondary particle size of from 30 to 100 nm on the weight basis. The polishing slurry is produced by pulverizing, using a high-pressure homogenizer, a silica-dispersed solution obtained by dispersing a fumed silica in an aqueous solvent, so that the fumed silica possesses an average secondary particle size of from 30 to 100 nm on the weight basis. The polishing slurry is used for polishing semiconductor wafers and inter-layer dielectric in an IC process.

U.S. Pat. No. 6,195,235 discloses a slider for supporting transducer elements in a data storage system including a granular particle composition including multiple layers of particles for providing a contact interface between the slider and disc surface. The multiple particle layers provide an uneven surface structure for stiction control. The multiple particle layers provide for wear while maintaining an uneven surface structure for stiction control.

U.S. Pat. No. 6,299,516 discloses a polishing layer for chemical mechanical polishing which includes a frozen binder material solution which has a liquid state at room temperature, and solid particles dispersed in the frozen binder material. The solid particles may be abrasives, such as colloidal silica or alumina, and/or non-reactive particles, such as pieces of polyurethane or polymerized resins. The polishing layer can also include a chemical etchant. The frozen polishing pad can be formed and reconditioned in situ.

U.S. Pat. No. 6,439,965 discloses a workpiece pinched from above and below by polishing pads attached to the inner surfaces of a pair of upper and lower rotary platens. A slurry is dropped between the workpiece and the polishing pads to polish the workpiece. The polishing pad is comprised of a base layer, and a sheet-shaped nap layer, which is laminated on the base layer and is made of a soft plastic foam. The nap layer is formed of closed pores, whose surface is covered with non-foaming skin layers and which involves pores (air bubble) in the nap layer without opening the pores in the surface. The polishing pad is used in combination with a colloidal slurry whose abrasive grains are colloidal silica in order to polish a surface of the workpiece.

U.S. Pat. No. 6,551,175 discloses a polishing composition comprising an abrasive and water, wherein the abrasive has a particle size distribution such that (1) a ratio of D90 to D50 (D90/D50) is from 1.3 to 3.0, and (2) D50 is from 10 to 600 nm, wherein D90 is defined as a particle size at 90% counted from a smaller size side on a number base in a cumulative particle size distribution, and wherein D50 is defined as a particle size at 50% counted from a smaller size side on a number base in a cumulative particle size distribution.

U.S. Pat. No. 6,699,115 discloses a polishing pad for a chemical mechanical polishing apparatus. The polishing pad includes a plurality of concentric circular grooves. The polishing pad may include multiple regions with grooves of different widths and spacings.

U.S. Pat. No. 6,793,559 discloses a method for polishing computer rigid disks comprising bringing at least one surface of the rigid disk into contact with a polishing pad and applying a composition to the rigid disk comprising at least one hydroxylamine additive and colloidal silica to give polished rigid disk.

U.S. Pat. No. 6,817,934 discloses an abrasive molding consisting essentially of inorganic particles having an average particle diameter in the range of 0.005 μm to 0.3 μm, and having a relative density in the range of 45% to 90%, provided that pores having a diameter of at least 0.5 μm are excluded from the molding. The abrasive molding is used for polishing a material to be polished by using a polishing liquid, preferably water or an aqueous solution of an alkali metal hydroxide, which does not contain a loose abrasive grain.

U.S. Pat. No. 6,852,020 discloses a polishing pad for use in chemical mechanical polishing of substrates that being made of a porous structure comprising a matrix consisting of fibers, such as cotton linter cellulose bound with a thermoset resin, such as phenolic resin. The polishing pad surface has voids in which polishing slurry flows during chemical mechanical polishing of substrates, and in which debris formed during the chemical-mechanical polishing of substrates is temporarily stored for subsequent rinsing away. The polishing surface of the pad is ground to form asperities that aid in slurry transport and polishing, as well as opening the porous structure of the pad. The porous pad contains nanometer-sized filler-particles that reinforce the structure, imparting an increased resistance to wear as compared to prior-art pads. Also disclosed is a method of making the polishing pad.

U.S. Pat. No. 6,932,677 discloses a polishing pad used for precise polishing of the surface of a lapped glass workpiece when a glass substrate for use in data recording media is manufactured from a glass workpiece. The polishing pad comprises a base and a polishing portion laminated on the base and contacting the surface of the glass workpiece at the time of polishing. The polishing portion is formed of a foam made of a synthetic resin having a 100% modulus of 11.8 MPa or less. A type of parameter representing the surface roughness of the polishing portion, namely, the maximum height (Rmax), is 70 μm or less.

U.S. Patent Publication 2002/0197935 discloses a method of polishing a substrate by providing a polishing slurry comprising water and silica particles, wherein the average size (by number) of the silica particles is less than 30 nm, providing a polymeric polishing pad substantially free of bound abrasive particles and having a polishing surface comprising a multiplicity of cavities, and polishing the surface of the substrate by contacting the polishing slurry and the polishing pad with the substrate and moving the polishing pad relative to the substrate.

U.S. Patent Publication 2003/0073385 discloses a self-cleaning colloidal slurry and process for finishing a surface of a glass, ceramic, glass-ceramic, metal or alloy substrate for use in a data storage device, for example. The slurry comprises a carrying fluid, colloidal particles, etchant, and a surfactant adsorbed and/or precipitated onto a surface of the colloidal particles and/or substrate. The surfactant has a hydrophobic section that forms a steric hindrance barrier and substantially prevents contaminates, including colloidal particles, from bonding to the substrate surface. The slurry is applied to the surface of the substrate while a pad mechanically rubs the surface. Subsequent cleaning with standard soap solutions removes substantially all remaining contamination from the substrate surface. In an exemplary embodiment, the slurry is used to superfinish a glass disk substrate to a surface roughness of less than 2 Å, with substantially no surface contamination as seen by atomic force microscopy (AFM) after standard soap cleaning steps.

U.S. Patent Publication 2003/0134575 provides a chemical-mechanical polishing system for a substrate comprising a liquid carrier, a polishing pad and/or an abrasive, a per-type oxidizer, and a phosphono group-containing additive, as well as a method of using the same to polish substrates, particularly nickel-containing substrates.

U.S. Patent Publication 2003/0135986 discloses a method for simultaneously planarizing to relatively equal smoothness a thin film magnetic head hardbaked resist structure having relatively low surface energy and one or more additional thin film magnetic head structures containing other materials having comparatively higher surface energy, such as copper, hardbaked resist, alumina and NiFe. The method begins with preparation of a chemical mechanical polishing (CMP) slurry targeted at equaling the removal rate of the materials to be planarized. The CMP slurry includes a liquid vehicle, an abrasive, and a surfactant. The CMP slurry is applied to the surface of the structures to be planarized and the structures are simultaneously planarized using a CMP planarization technique.

U.S. Patent Publication 2004/0127147 discloses a polishing composition for memory hard disk containing water and silica particles, wherein the silica particles have a particle size distribution in which the relationship of a particle size (R) and a cumulative volume frequency (V) in a graph of particle size-cumulative volume frequency obtained by plotting a cumulative volume frequency (%) of the silica particles counted from a small particle size side against a particle size (nm) of the silica particles in the range of particle sizes of from 40 to 100 nm satisfy the following formula (1):
V≧0.5×R+40 (1),
wherein the particle size is determined by observation with a transmission electron microscope (TEM). The polishing composition of the present invention can be even more suitably used for the manufacture of a substrate for precision parts such as substrates for memory hard disks.

U.S. Patent Publication 2004/0137830 discloses an object such as an electronic device can be favorably lapped by a method composed of preparing a lapping machine having a longitudinal or circular lapping board equipped with a ultrasonic oscillation-applying device which applies elliptical vibration to the lapping board and a supporting means arranged adjacently to the lapping board; placing the object on the lapping board via abrasive grains and further on the supporting means; and activating the ultrasonic oscillation-applying device to apply elliptical vibration to the lapping board whereby the object is caused to rotate on an axis thereof and lapped.

U.S. Patent Publication 2005/0054273 discloses a polishing kit for a magnetic disk containing (A) a slurry containing an alumina, (B) an oxidizing agent solution containing an oxidizing agent, and (C) an acid agent solution containing an acid; a polishing kit for a magnetic disk containing (A) a slurry containing an alumina, and (D) an additive solution containing an oxidizing agent and an inorganic acid; and a polishing kit for a magnetic disk containing (A) a slurry containing an alumina, and (C) an acid agent solution containing an acid, wherein the polishing kit is used with an oxidizing agent solution (B) containing an oxidizing agent; and a polishing process for a magnetic disk substrate, including the steps of feeding a liquid mixture containing components of a specified polishing kit to a space between the magnetic disk substrate and a polishing cloth; and polishing the magnetic disk substrate with the liquid mixture. The polishing composition kit can be suitably used for the manufacture of high-quality magnetic disk substrates such as hard disks.

U.S. Patent Publication 2005/0148290 provides a method for polishing a substrate comprising a metal in an oxidized form, the method comprising the steps of: (a) providing a substrate comprising a metal in an oxidized form, (b) contacting a portion of the substrate with a chemical-mechanical polishing system comprising: (i) a polishing component, (ii) a reducing agent, and (iii) a liquid carrier, and (c) abrading at least a portion of the metal in an oxidized form to polish the substrate. The reducing agent can be selected from the group consisting of 3-hydroxy-4-pyrones, α-hydroxy-γ-butyrolactones, ascorbic acid, borane, borohydrides, dialkylamine boranes, formaldehyde, formic acid, hydrogen, hydroquinones, hydroxylamine, hypophosphorous acid, phosphorous acid, a metal or metal ions in an oxidation state having a standard redox potential that is less than the standard redox potential of the metal in an oxidized form, trihydroxybenzenes, solvated electrons, sulfurous acid, salts thereof, and mixtures thereof.

U.S. Patent Publication 2005/0208883 relates to a polishing composition containing an aqueous medium and silica particles, wherein the silica particles in the polishing composition has a zeta potential of from −15 to 40 mV; a method for manufacturing a substrate including the step of polishing a substrate to be polished with a polishing composition containing an aqueous medium and silica particles, wherein the silica particles in the polishing composition has a zeta potential of from −15 to 40 mV; and a method for reducing scratches on a substrate to be polished with a polishing composition containing an aqueous medium and silica particles, including the step of adjusting a zeta potential of silica particles in the polishing composition to −15 to 40 mV. The polishing composition can be favorably used in polishing the substrate for precision parts, including substrates for magnetic recording media such as magnetic discs, optical discs and opto-magnetic discs; photomask substrates; optical lenses; optical mirrors; optical prisms; semiconductor substrates; and the like.

U.S. Patent Publication 2005/0215179 provides a polishing pad substrate comprising a copolymer, wherein the copolymer has at least one hydrophilic repeat unit and at least one hydrophobic repeat unit. The invention also provides a polishing pad substrate comprising a polymer, wherein the polymer is a modified polymer having at least one hydrophilic unit and at least one hydrophobic unit attached to the polymer chain. The invention further provides a method of polishing a workpiece comprising (i) providing a workpiece to be polished, (ii) contacting the workpiece with a chemical-mechanical polishing system comprising the polishing pad substrate of the invention, and (iii) abrading at least a portion of the surface of the workpiece with the polishing system to polish the workpiece.

U.S. Patent Publication 2005/0221726 relates to a polishing composition containing an abrasive having an average particle size of from 1 to 30 nm and water, wherein the abrasive has a packing ratio of from 79 to 90% by weight; a method for manufacturing a substrate, including the steps of introducing the above polishing composition between a substrate and a polishing pad, and polishing the substrate, while contacting the substrate with the polishing composition; and a method for reducing scratches of a substrate to be polished, including the step of polishing the substrate to be polished with the above polishing composition. The polishing composition is suitable for polishing substrates for precision parts including, for example, substrates for magnetic recording media, such as magnetic disks, and opto-magnetic disks, photomask substrates, optical disks, optical lenses, optical mirrors, optical prisms and semiconductor substrates, and the like.

In spite of these disclosures, there is still a great need for a method for treating a slider head to prevent stiction between the surface of the hard disk and the slider head.

### SUMMARY OF THE INVENTION

It is an object of the invention to provide an improved slider head for reading and writing information on a hard disk.

It is another object of the invention to provide a slider head capable of operating at a distance of 50 to 100 Å from the hard disk surface without stiction.

It is yet another object of the invention to provide a slider head having a texturized surface for operating close to the surface of a hard disk without stiction.

Yet, it is another object of the invention to provide a method for texturing the surface of a slider on a read/write head to permit the slider to operate very close to hard disk surface without stiction.

And, it is another object of the invention to provide a slurry for texturing the surface of a slider on a read/write head to permit the slider to operate very close to a hard disk surface without stiction.

Further, it is yet another object of the invention to provide an improved lapping pad for texturing the surface of a slider on a read/write head for operating very close to the surface of a hard disk.

It is still another object of the invention to use a texture pad to round off edges of the slider to minimize head damage to the hard disk during operation.

These and other objects will become apparent from a reading of the specification and claims and an inspection of the drawings appended hereto.

In accordance with these objects, there is provided a method of texturing a slider surface on a magnetic head for reading and writing information on a hard disk, the texturing applied to prevent stiction between the head and the slider surface. The method comprises the steps of providing a sliding head having a surface having a smoothness of about 6 Å or less to provide a polished surface. The polished surface is textured by contacting it with a texturing pad having a texturing surface comprised of a polyester material and a slurry comprised of colloidal silica. The polished surface is treated with the texturing pad and colloidal silica to provide a surface having a roughness greater than that of the polished surface. The polished surface avoids stiction between the slider surface and the hard disk.

Another aspect of the invention includes a system for texturing a surface of a slider head to avoid stiction between the surface of the slider head and a surface of a hard disk wherein in the system, the texturing employs a colloidal silica slurry having a concentration of 1 to 5 vol. %, the remainder water.

In another aspect of the invention, a texturing pad is employed for applying colloidal silica to texture the surface of a slider of a magnetic head for reading and writing information on a surface of a hard disk. The pad is comprised of a layer of felt comprised of polyester fibers, the felt impregnated with a polyurethane binder. The pad may be needle punched to facilitate impregnation of the binder.

### BRIEF DESCRIPTION OF THE DRAWINGS

FIG. 1 is a schematic representation of a magnetic and hard disc for reading and writing information on a hard disk.

FIG. 2 is a schematic representation showing a magnetic head in relationship to the surface of a hard disk.

FIG. 3 is a top view of a texturing pad for treating the slider of a magnetic head.

FIG. 4 is a cross-sectional view along the line A-A of FIG. 3 showing a structure of the texturing pad.

### DETAILED DESCRIPTION OF PREFERRED EMBODIMENTS

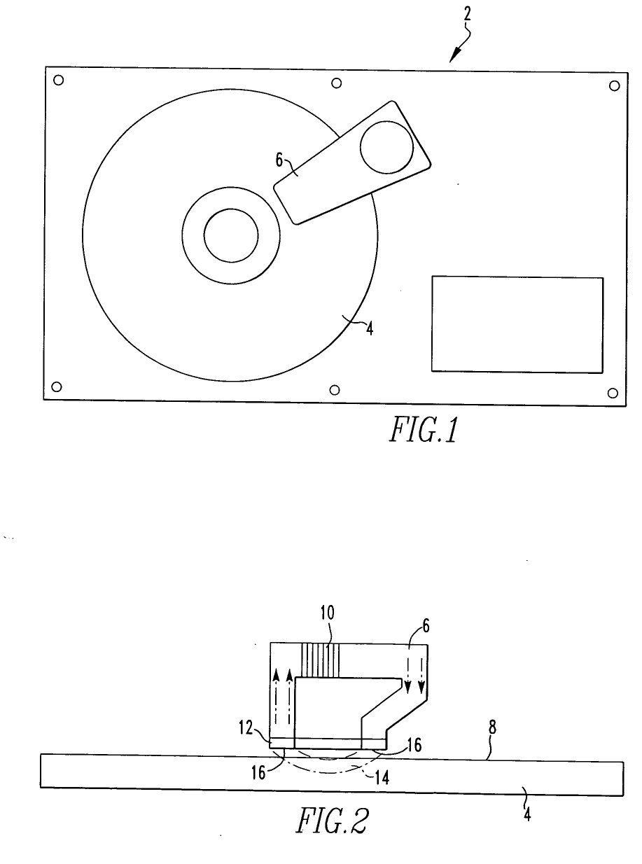

Referring now to FIG. 1, there is illustrated a top view of a disc drive 2 illustrating a hard disc 4 and a magnetic head 6 which is employed for reading and writing information to hard disk 4. The disk drives may be used in computers, digital video recorders, cell phones, electronic appliances, and other systems which use disk drives for memory storage.

As noted, head 6 reads and records information on a magnetizable disk. Such disks are usually comprised of a nickel-plated aluminum substrate or glass substrate. The nickel coating is polished and then textured using tape before thin films of chromium, cobalt and carbon are sputtered onto it. This is followed by a thin lubrication film, usually a fluorocarbon. During operation, disk 4 rotates at 7000 to 9000 rpm. The heads are referred to as GMR (giant magnetic resistive heads), TMR (tunneling magneto resistive heads) or PMR (perpendicular sputtered heads).

Read/write head 6 and disk 4 are illustrated in cross section in FIG. 2. It should be noted that head 6 is comprised of a transducer 10 which creates a magnetic field 14 which interacts with disk 4. Further, head 6 is comprised of a slider portion 12 whose surface 16 comes very close to disk surface 8. Slider portion 12 has sharp shoulders which are preferably rounded to avoid damages to the disk. That is, the slider surface 16 can operate at 50 Å to 100 Å or less from surface 8 of hard disk 4 to efficiently read and write information to the disk.

Read/write head 6 is typically formed from a sintered composite of titanium carbide bound with aluminum oxide, often referred to as “altic”.

In preparation for use, the surface of the slider is lapped or polished on a lapping machine to provide a smooth surface. The lapping machine typically has a rotating table formed from a tin alloy. Also, typically the rotating table has circumferential grooves. For purposes of polishing, the rotating table is charged with a polishing compound comprised of a mixture or slurry of fine polycrystalline diamonds and oil. The fine polycrystalline diamonds range in size from about 100 to 200 NM. After polishing, the slider surface is flat and smooth, having a roughness of less than about 5 Å. When the head is used to transmit data to or from a hard disk, it operates at a distance of about 50 to 100 Å from the hard disk surface. However, such operation can have the problem of stiction between the surface of the slider head and the surface of the hard disk. That is, a certain force is required to move the head from rest relative to the surface of the hard disk.

Thus, it has been discovered that the slider surface can be treated to minimize or eliminate stiction forces. After polishing, slider head surface 16 is treated in accordance with the invention to minimize or eliminate stiction forces.

Thus, in accordance with the invention, the slider head surface is textured to minimize or avoid stiction with the surface of the hard disk. To obtain the texturing finish, the slider surface is treated with a novel texturing pad and slurry.

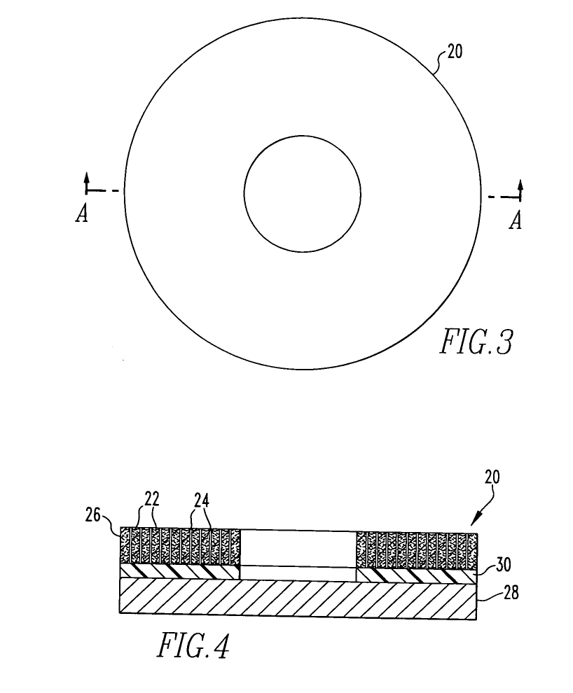

As shown in FIG. 3, texturing pad 20 is generally circular in shape and may have a circular opening in the middle. It will be appreciated that other shapes may be used. Pad 20 can have a thickness in the range of about 0.5 mm to 2.5 mm with a typical thickness being about 0.55 mm. Pad 20 is typically about 15 inches in diameter in order that it may be used on a standard lapping machine, such as that available from Engis Corporation, 105 West Hintz Road, Wheeling, Ill. 60090.

Texturing pad 20 is comprised of a non-woven or felt material. Preferably, the felt material is comprised of polyester fibers. However, other fibers, such as nylon and microporous cast polyurethane may be used. Typically, in forming the pad, the fibers are compressed to form the felt. Then, the felt is needle punched. Thereafter, the punched felt is treated with a binder to hold the punched felt together. Preferably, the binder is a polyurethane binder. Other pads such as a flocked pad which has a higher map may be used to provide finishing touches to difficult to reach slider parts.

Pad 20 is illustrated in cross section in FIG. 4 where it is shown attached to a lapping wheel 28. It will be noted that fibers 22 are non-woven or randomly arranged to provide the felt material. Openings 24, resulting from needle punching, are also illustrated. Needle punching facilitates the absorption of the binder into the felt material. Such material is available from Thomas West Inc., 470 Mercury Drive, Sunnyvale, Calif. 94085.

Referring again to FIG. 4, it will be noted pad 20 is illustrated as top layer 26. Pad 20 is attached to lapping table 28 using a double-backed adhesive 30.

For purposes of texturing the surface of the slider head, a slurry is used in conjunction with pad 20 to provide a surface which is substantially free from stiction with hard disk surface. The slurry is comprised of colloidal silica at a concentration that promotes texturing, which is typically in the range of about 1 to 5 vol. %. In addition, the colloidal silica is required to have a controlled particle size to provide a suitable texture on the surface of the slider head. Typically, the particle size can range from 5 to 150 NM, with a preferred size in the range of about 15 to 50 NM.

For purposes of texturing and avoiding etching of the slider surface, the colloidal silica is required to be maintained in a controlled pH range. Thus, for purposes of the invention, the pH of the colloidal silica can range from 9 to 10 with the preferred pH being in the range of about 9.2 to 9.7. The correct pH range is important because it maximizes stock removal. While reference has been made to colloidal silica, it is believed that other colloids, such as colloidal alumina, fumed alumina or summed silica can also be used.

In the process of the present invention, the surface of the slider head closest to the hard disk surface is first ground to provide flatness. The slider head surface is lapped or polished to provide for smoothness. Lastly, the smooth slider head surface is texturized to provide a controlled roughness, which minimizes or avoids stiction with the surface of the hard disk. Typically, the wheel speed of the lap machine using the improved pad is 30 rpm. Also, typically, the roughness required or obtained by the use of the present process is just slightly rougher than the starting Ra.

In another aspect of the invention, the textured pad may be used to round off edges of the slider to minimize head damage to the hard disk during operation. The rounding process uses an alkaline material such as sodium hydroxide or potassium hydroxide in a pH range of about 9 to 9.7.

### EXAMPLE

A slider surface, after grinding and polishing, had a smoothness of 6 Å Ra. When tested on a read/write head, the slider was subject to stiction. The slider head surface was subjected to a texturized treatment using a 5 vol. % slurry of colloidal silica and a lapping machine employing a felt polyester pad. The pad was needle punched and coated with polyurethane before curing. The colloidal silica was made from a 30% vol. % solution of colloidal silica at a pH of 8.9. This solution was diluted with deionized water to provide the 5% solution having a pH of 9.2 The 5% colloidal silica solution was added to the pad and the lapping wheel turned at 30 rpm while the slider surface was in contact. When the textured head was used on a read/write application, it was found to be free of stiction.

Having described the presently preferred embodiments, it is to be understood that the invention may be otherwise embodied within the scope of the appended claims.

What is claimed is:

1. A method of texturing a slider surface on a magnetic head for reading: and writing information on a hard disk, the texturing applied to prevent stiction between said hard disk and the slider surface, the method comprising the steps of:
(a) providing a sliding head having a surface having a smoothness of 6 Å or less to provide a polished surface;
(b) texturing the polished surface by contacting said polished surface with a texturing pad having a texturing surface comprised of a polyester material and a slurry comprised of colloidal silica; and
(c) treating said polished surface with said texturing pad and colloidal silica to provide a surface having a roughness greater than said polished surface and which avoids stiction between said slider surface and said hard disk.

2. The method in accordance with claim 1 wherein said texturing pad employs a layer of felt.

3. The method in accordance with claim 2 wherein said polyester material is bonded with polyurethane adhesive to provide said felt.

4. The method in accordance with claim 1 wherein said colloidal silica slurry is a water based slurry.

5. The method in accordance with claim 4 wherein said slurry comprises 1 to 5 vol. % colloidal silica.

6. The method in accordance with claim 5 wherein said colloidal silica has a particle size between 15 to 50 nanometers.

7. The method in accordance with claim 5 including maintaining said slurry in a pH range of 9 to 10.

8. The method in accordance with claim 5 including maintaining said slurry in a pH range of 9.2 to 9.7.

9. In a system for texturing a surface of a slider head to avoid stiction between the surface of the slider head and a surface of a hard disk wherein in said system, said texturing employs a colloidal silica slurry having a concentration of 1 to 5 vol. %, the remainder water.

10. The slurry in accordance with claim 9 including using colloidal silica having a size in the range of about 15 to 50 nanometers.

11. The slurry in accordance with claim 9 including maintaining said colloidal silica slurry at a pH in the range of about 9 to 10.

12. The slurry in accordance with claim 9 including maintaining said colloidal silica slurry at a pH in the range of about 9.2 to 10.

13. The system in accordance with claim 9 including applying said colloidal silica to said surface of said slider head employing a lapping pad having a surface layer of polyester fibers formed into a felt.

14. The pad in accordance with claim 13 wherein said polyester fibers are bonded with a polyurethane adhesive.

15. A texturing pad suitable for applying colloidal silica to texture the surface of a slider head of a magnetic head for reading and writing information on a surface of a hard disk, said pad comprised of a layer of polyester fibers bonded together to form a felt.

16. The pad in accordance with claim 15 wherein said polyester fibers are bonded with a polyurethane adhesive.

17. The pad in accordance with claim 16 wherein said felt is needle punched prior to applying said polyurethane adhesive.

18. A slider suitable for supporting transducer elements of a read/write head in a data storage system, the slider comprised of a lower face and an upper face attached to a transducter element, the lower face having a texturized finish resulting from treating the lower surface with colloidal silica at a pH of 9.2 to 9.7 and having a particle size between 15 to 50 nanometers using a texturing pad comprised of polyester fiber felt bonded with a polyurethane.

19. A method of texturing a slider surface on a magnetic head for reading and writing information on a hard disk, the texturing applied to prevent stiction between said hard disk and the slider surface, the method comprising the steps of:
(a) providing a sliding head having a surface having a smoothness of 6 Å or less to provide a polished surface;
(b) texturing the polished surface by contacting said polished surface with a texturing pad having a texturing surface comprised of a polyester material and a slurry comprised of colloidal silica;
(c) treating said polished surface with said texturing pad and colloidal silica to provide a surface having a roughness greater than said polished surface and which avoids stiction between said slider surface and said hard disk; and
(d) rounding off shoulders on said sliding head by treating with a pad and an alkaline solution at a pH of 9 to 9.7.

20. A method of texturing a slider surface on a magnetic head for reading and writing information on a hard disk, the texturing applied to prevent stiction between said hard disk and the slider surface, the method comprising the steps of:
(a) providing a sliding head having a surface having a smoothness of 6 Å or less to provide a polished surface;
(b) texturing the polished surface, said surface having a roughness greater than said polished surface and which avoids stiction between said slider surface and said hard disk; and
(c) rounding off shoulders on said sliding head by treating with a pad and an alkaline solution at a pH of 9 to 9.7.

21. The method in accordance with claim 19 wherein the alkaline solution is comprised of NaOH or KOH.

22. The method in accordance with claim 20 wherein the alkaline solution is comprised of NaOH or KOH.
